(19) United States
(12) Patent Application Publication
(10) Pub. No.: US 2014/0316915 A1
(43) Pub. Date: Oct. 23, 2014

(54) VISUALLY ADAPTIVE PROCESS IMPROVEMENT SYSTEM FOR ORDER TAKING

(71) Applicant: SEALED AIR CORPORATION, Elmwood Park, NJ (US)

(72) Inventors: William V. Hickey, Franklin, NJ (US); Lawrence J. Pillote, Naperville, IL (US); Nicholas P. DeLuca, Washington, DC (US); Koichi Sato, Saratoga, CA (US); Xia Lu, Austin, CA (US)

(21) Appl. No.: 14/348,305

(22) PCT Filed: Sep. 28, 2012
(86) PCT No.: PCT/US2012/057792

§ 371 Date: Mar. 28, 2014

Related U.S. Application Data
(60) Provisional application No. 61/541,783, filed on Sep. 30, 2011.

(51) Int. Cl. G06Q 30/06; H04N 7/18; G06K 9/00; G06Q 50/12

(52) U.S. Cl. CPC G06Q 30/0633; G06Q 50/12; H04N 7/183; G06K 9/00228; G06K 9/00536
USPC 705/15

(57) ABSTRACT

A system for order taking formed with one or more computers, cameras, computer networks and vision based computer algorithms and designed to visually obtain information to facilitate and obtain an order. The system's applications including drive through orders, kiosks, vending machines and other automated ordering or points of sale. The system further tailored for people with hearing or speaking disabilities as well as improving the process of cleanup and preparation for the next customer.

### BACKGROUND

Vending from kiosks, drive-throughs, vending machines, and other automated ordering or points of sale systems are a large market. These systems are designed to eliminate or significantly reduce human labor and the interpretation and inefficiency that is normally present when ordering directly with a person; for example in a location such as a restaurant. There are many sources of inefficiency which are present with placing an order directly with a person. Specifically, travel time for the server and item ordered, wait time for the server and order, packing of food if the order is a take out food order, communication difficulties associated with placing an order (e.g. items requested, number of items, quality or other difficulties of order), mixing, missing, or mislabeling orders associated with multiple ‘members’ or even repeat ordering for people, handling of cash or other payments, as well as trash removal and clean-up. Further, ordering in person does not allow for a “memory” of repeat orders for repeat customers.

Automated vending systems solve many of the issues associated with order inefficiency, by trying to collocate the customer product, and payment, and further minimizing cleanup. This is true for product vending machines, kiosks, ATMs, and other machine systems. In the case of drive through vending, the use of acoustics for tele-ordering and the placement of the food and payment along a path that is traveled by a customer in a vehicle increases efficiency. In all cases though, the actual ordering or communication of the order along with the specifications of the order as well as the facilitation of repeat orders is still a major source of inefficiency independent of the automation system used.

### OBJECTS OF INVENTION

Therefore it is a significant object of the present invention to facilitate the ordering process from “kiosks . . . etc” and other automated or semi-automatic ordering systems by providing:
An easy to integrate non-contact method to recall information about a customer
Improved user access to communication devices
Facilitated communication tools for ordering systems
Improved order checking and communication of ordered items for the further purpose of preventing mixed, missed, or mislabeled orders.
Facilitated post order process such as cleaning or preparation for the next customer.

It is a further objective of the following invention to provide a biometric identification system that can easily be integrated with existing order systems and does not require direct physical contact.

It is a further objective of the following invention to provide a non-contact, non-acoustic feedback method for a customer using an ordering system.

It is a further objective of the invention to provide a completed order only when specific steps are completed, which may include placing the order, receiving the order, payment for the order, receipt of payment in authorized areas (registers, networks, etc), cleanup of a used area, and re-initiation of the system in preparation for another order.

### SUMMARY OF INVENTION

In summary, the invention comprises of a process for facilitating the ordering of food or merchandise through a networked system of computer vision cameras, robotics, and specialized computer algorithms for associating real time customer information as well as order information to an open order. The system may be composed of the following primary constituent computer vision based components: a customer pre order evaluation, a facilitated order process, an order delivery evaluation unit, a customer satisfaction module, a billing or payment evaluation unit, and a cleanliness, trash pickup, and sanitation survey unit. The process may further be coupled with computer algorithms used in association with single or multiple cameras, computers, routers, robotics, telecommunication systems, point of sale units, drive through vending systems and their associated architectural layout, vending machines, ATMs, kiosks, or other automatic or semiautomatic vending equipment or process. The system and process may further enable the visual confirmation of a “yes” or “no” answer from a customer through the visual monitoring of the customer. The system may utilize both two dimensional and three dimensional data from the customer and order environment.

The invention will be herein further described in connection with the following figures, photographs, tables and schematics.

### FIGURES

The same reference number represents the same clement on all drawings. It should be noted that the drawings are not necessarily to scale. The foregoing and other objects, aspects, and advantages are better understood from the following detailed description of a preferred embodiment of the invention with reference to the drawings, in which:

FIG. 1 is a schematic diagram of the order facilitation process according to one embodiment.

FIG. 2 is a drawing of a drive through order facility using an order facilitation process according to one embodiment.

FIG. 3 is an isometric view of a vending machine and the associated environment using an order facilitation process according to one embodiment.

FIG. 4 is an isometric view of an in-house restaurant using an order facilitation process according to one embodiment.

FIG. 5 is a flow chart describing an order facilitation process according to one embodiment used within a restaurant.

FIGS. 6a and 6b describe a visual detection process for determining a customer's use of the words “yes” and “no” used in connection with an order facilitation process according to one embodiment.

FIGS. 7a and 7b illustrate a visual detection system for tracking and confirming cleanliness at a table or in the customer environment used in connection with an order facilitation process according to one embodiment.

FIGS. 8a and 8b illustrate a visual detection system for the fraudulent swiping of credit cards in a customer drive through setting used in connection with an order facilitation process according to one embodiment.

FIGS. 9a and 9b illustrate a visual detection system for non contact biometric sensing used in connection with the following invention with an order facilitation process according to one embodiment.

### DESCRIPTION

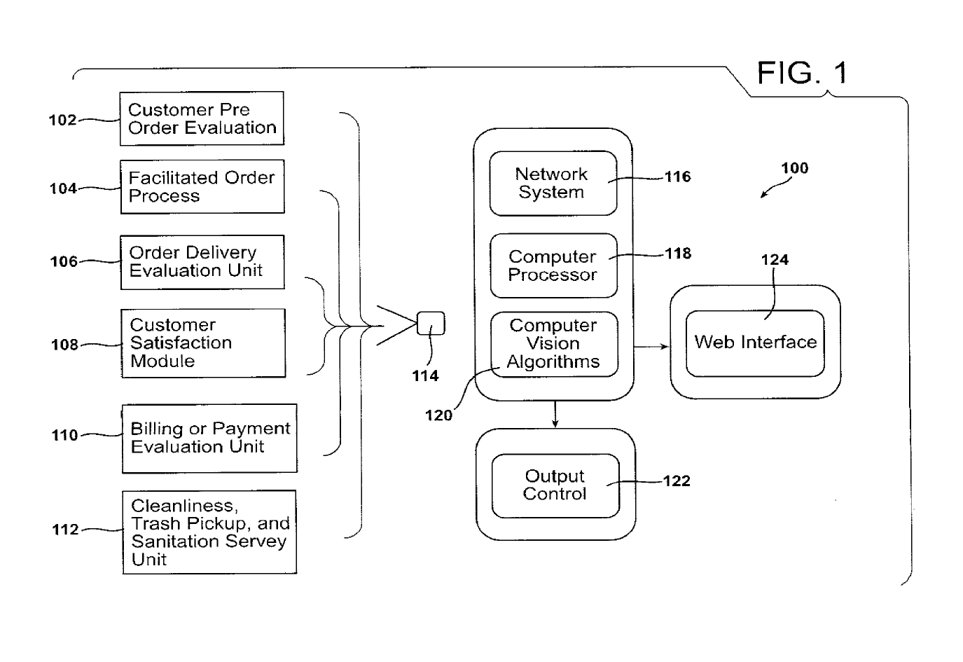

FIGS. 1-9b and the following descriptions depict specific embodiments to teach those skilled in the art how to make and use the best mode of the teachings. For the purpose of teaching these principles, some conventional aspects have been simplified or omitted. Those skilled in the art will appreciate variations from these embodiments that fall within the scope of the teachings. Those skilled in the art will also appreciate that the features described below can be combined in various ways to form multiple variations. As a result, the teachings are not limited to the specific embodiments described below, but only by the claims and their equivalents.

As used herein, a “non-contact biometric identification system” or “vision detection system” refers to method that correctly identifies a person performing a particular merchandise or consumable product order without contact based upon a particular characteristic of that individual by 1) sufficiently imaging or recording the individual placing the order; 2) sufficiently comparing that image or recording to a database of images or audio recordings; 3) sufficiently identifying the individual person based upon comparisons the database(s); and 4) sufficiently processing and/or compiling representative data reporting the detecting of the identity of the individual placing the order. The characteristic may include physiological or behavioral characteristics of a person, including but not limited to, shape, body, fingerprint, palm print, facial recognition, DNA, geometry (body, hand etc.), iris, retina, odor, posture, gait, and/or voice. The “non-contact biometric identification system” or “vision detection system” must: 1) utilize visual or audio based technology to “see” (e.g. image) or “hear” (e.g. audio record) a person in order to establish the identity of the person. This can be done by previous exposure to a person, or due to the first experience with a person. For example, all customers of a drive through fast food restaurant can be photographed from specific cameras capable of capturing specific poses, or have specific portions of their body imaged (e.g. face, hands, head, etc.) with each visit to the restaurant. The images may then be stored on a data network for later comparison. In one embodiment, voice recordings of all customers of a drive through are made, and particular words or phrases (e.g. their name, “yes” or “no”, etc.) are recorded for later comparison. The non-contact biometric identification system can then utilize those stored images and audio files to identify the customer or patron in subsequent visits. The “non-contact biometric identification system” or “vision detection system” may utilize a vision camera, webcam or similar device for capturing video or images.

As shown in FIG. 1, an embodiment of process 100 for increasing the efficiency of an ordering process comprising customer (or consumer) pre-order evaluation 102, facilitated order process 104, an order delivery evaluation unit 106, a customer service module 108, a billing or payment evaluation unit 110 and a cleanliness, trash pickup and sanitation survey unit 112 is described. At every step, a vision camera 114 may facilitate the step by taking images of a user or an employee. The images may be transmitted to a network system 116 processed via computer processor 118, where the data from the images are subjected to a variety of algorithms 120 that generate reporting data regarding output control 122. The data may also be subjected to a web interface 124 to be received by remote users of the system. Customer pre-order evaluation 102 may be, for example, a license plate, facial recognition, hand recognition, credit card recognition, etc. Facilitated order process 104 may be, for example, a telescoping microphone, a moveable videoscreen, etc. Order delivery evaluation unit 106 may be, for example, time of service, quality of food, pleasant and/or clean atmosphere, smile of service person, etc. Billing or payment evaluation unit 110 may be, for example, processing of credit or debit card based on visual image, evaluation of employee's processing of payment, etc. Cleanliness, trash pickup, and sanitation survey unit 112 may, for example, evaluate cleanliness of station, alert(s) of area(s) to be cleaned, alert(s) of area(s) properly cleaned, etc.

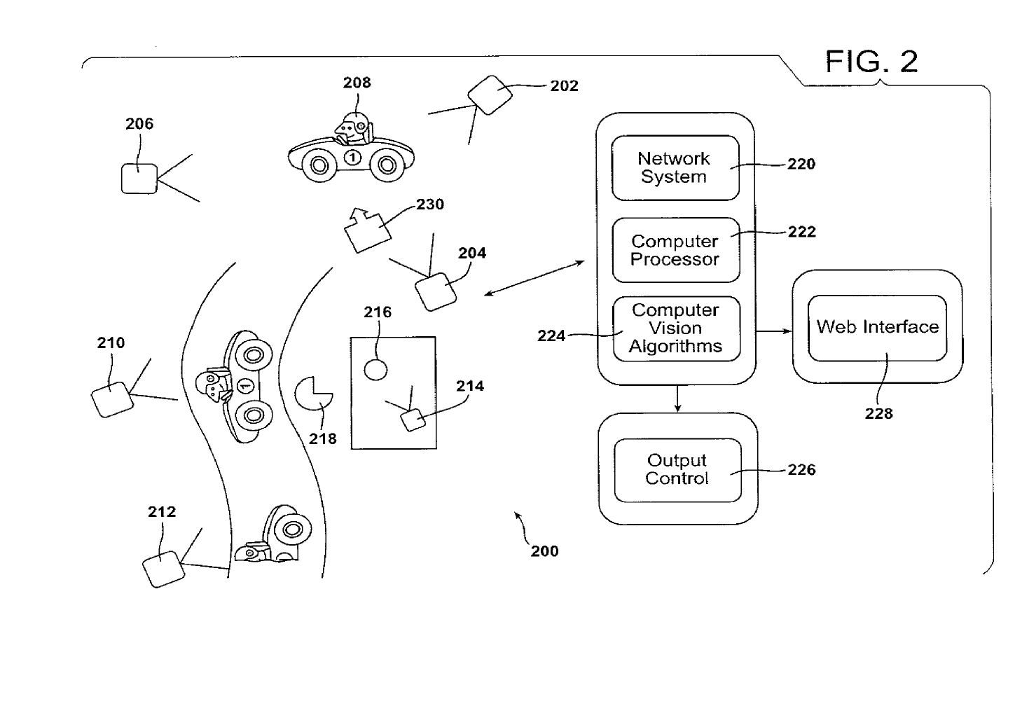

As shown in FIG. 2, an embodiment of process 200 for increasing the efficiency of an ordering process at a drive-through is described. In this embodiment, camera 202 can be strategically places to locate a car's license plate; camera 204 can be strategically placed to view the user approaching the ordering station; camera 206 can be strategically placed to view the face of driver 208 placing the order; camera 210 can be strategically placed to view the user at the drive through window; and camera 212 can be strategically placed to view the driver after he has received his food and is leaving the area of the drive through. A separate camera 214 can be located within the drive-through window, which views the employee 216 distributing the processing of payment, and delivering goods 218 to user. The images may be transmitted to a network system 220 processed via computer processor 222, where the data from the images are subjected to a variety of algorithms 224 that generate reporting data regarding output control 226. The data may also be subjected to a web interface 228 to be received by remote users of the system. Information from different cameras may provide important details regarding time of user at ordering station, total time of visit from pull-up to leaving. In order to facilitate the users experience, a telescoping microphone or menu screen 230 may be used when the car approached the ordering menu. Sensors may be strategically placed to alert when a user is at the ordering menu station. At which time, the telescoping microphone may telescope both horizontally and vertically to within a specific distance of a vehicles window. In some instances it may reach about 1-4 feet. In some instances it may reach less than 1 foot of the cars window.

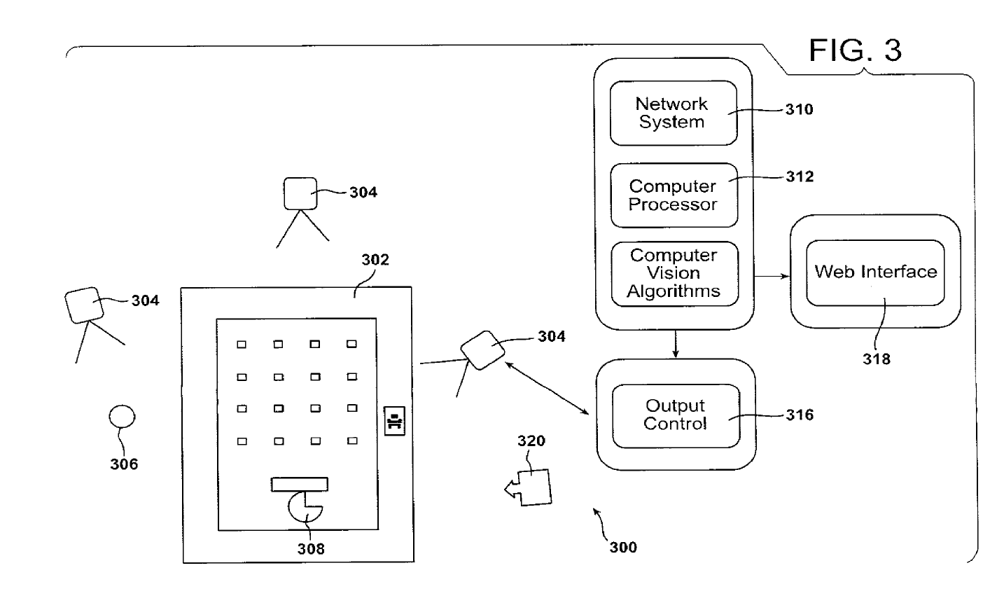

As shown in FIG. 3, an embodiment of process 300 for increasing the efficiency of an ordering process at vending machine 302 is described. In this embodiment, cameras 304 can be strategically places to locate user 306, to view user 306 approaching a vending station at vending machine 302, with at least one camera 304 viewing the face of the user 306 placing the order, and with a camera 304 viewing the user 306 from above vending machine 302 and a camera 302 viewing the user (or driver) 306 after he has received his food 308 and is leaving the area of vending machine 302. The images may be transmitted to a network system 310 processed via computer processor 312, where the data from the images are subjected to a variety of algorithms 314 that generate reporting data regarding output control 316. The data may also be subjected to a web interface 318 to be received by remote users of the system. Information from different cameras may provide important details regarding time of user at the vending machine, total time of visit from step-up to leaving, etc. In order to facilitate the user's experience, a telescoping microphone or menu screen 320 may be used when user 306 approaches vending machine 302. Sensors may be strategically placed to alert when user 306 is at vending machine 302. At which time, telescoping microphone 304 may telescope both horizontally and vertically to within a specific distance of the body of user 306. In some instances it may reach about 1-4 feet. In some instances it may reach less than 1 foot of the body or face of user 306.

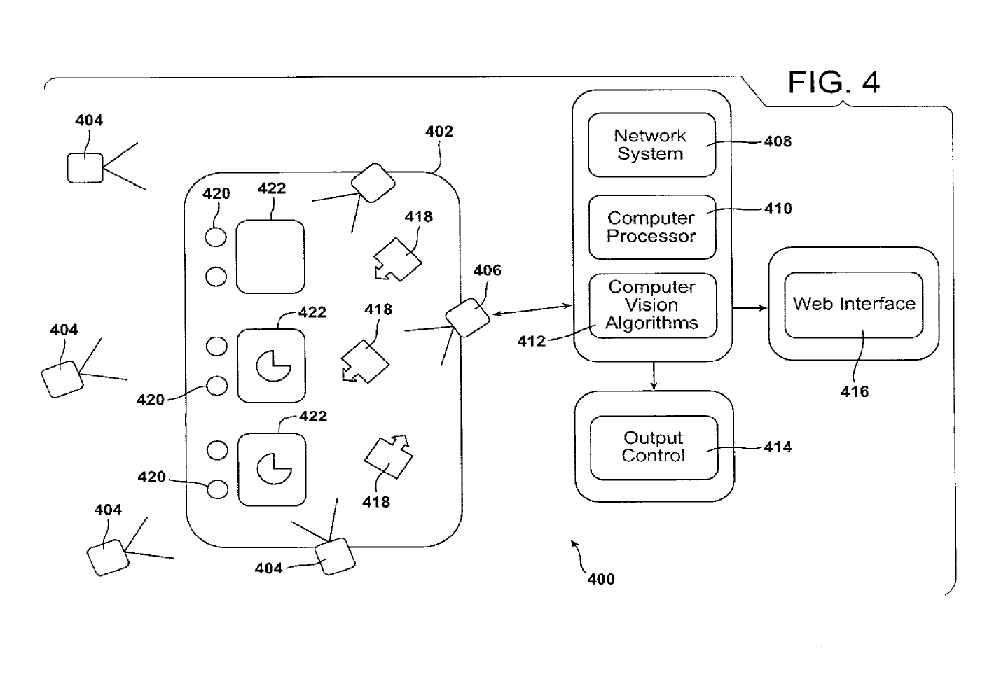

As shown in FIG. 4, an embodiment of process 400 for increasing the efficiency of an ordering process at restaurant 402 is described. In this embodiment, cameras 404 can be strategically places to locate a specific table, to view a consumer at a particular table, a camera to view the table top of a particular table, etc. A separate camera 406 can be located within the entryway of the restaurant, which views the patron upon arrival and leaving of the restaurant (not illustrated). The images may be transmitted to a network system 408 processed via computer processor 410, where the data from the images are subjected to a variety of algorithms 412 that generate reporting data regarding output control 414. The data may also be subjected to a web interface 416 to be received by remote users of the system. Information from different cameras 404, 406 may provide important details regarding time of user at the restaurant, total time of visit from entry to exit, etc. In order to facilitate the user's experience, a telescoping microphone or menu screen 418 may be used when users 420 are seated at tables 422. Sensors (not illustrated) may be strategically placed to alert when a user 420 is at a table 422. At which time, the telescoping microphone or menu screen 418 may telescope both horizontally and vertically to within a specific distance of the body of a user 420 or the table 422 of the user. In some instances it may reach about 1-4 feet. In some instances it may reach less than 1 foot of the body of the user 420 or table 422.

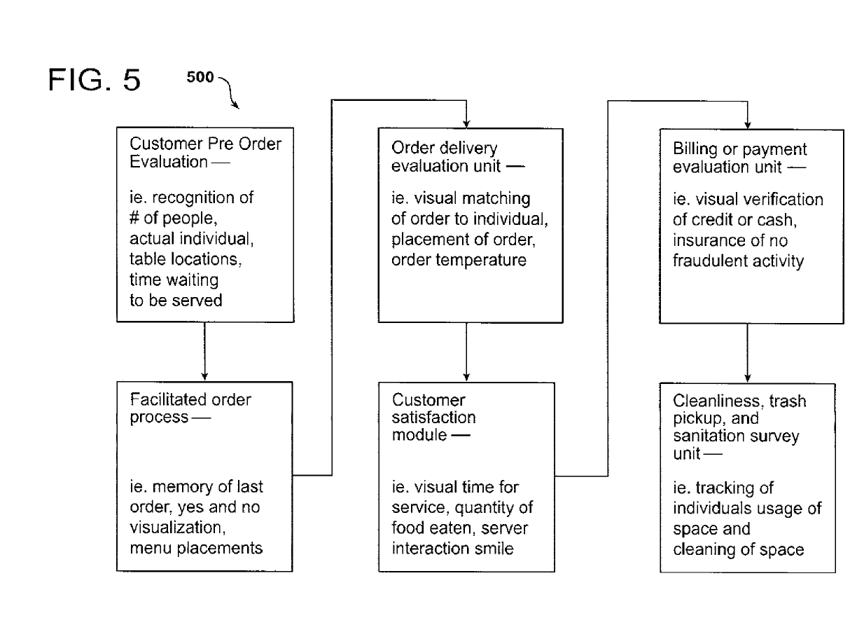

As shown in FIG. 5, an embodiment of a process for increasing the efficiency of an ordering process 500 for a food product is described.

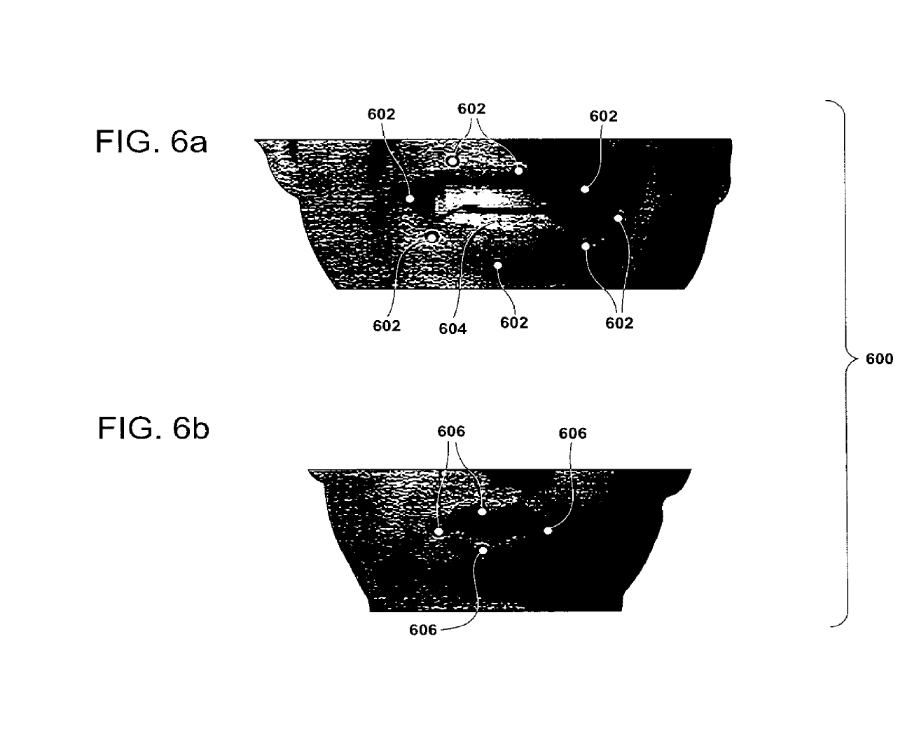

As shown in FIGS. 6a and 6b, a non-contact biometric system 600 capable of detecting a user's mouth features when saying specific words is shown. In as shown in FIG. 6a, the topographical landmarks 602 of key aspect of a pair of lips when a user says the word “yes” may be received by a vision camera (not illustrated) and digitally recorded. In some instances, additional facial features, such as teeth 604, dimples, nose, ears, etc. may be utilized to further visually detect when a user says the word “yes.” In some embodiments, the images are saved to a network for future use. In as shown in FIG. 6b, the topographical landmarks 606 of key aspect of lips when a user says the word “no” may be received by a vision camera (not illustrated) and digitally recorded. In some instances, additional facial features, such as teeth, dimples, nose, ears, etc. may be utilized to further visually detect when a user says the word “no.” In some embodiments, the images are saved to a network for future use. In some embodiment, additional words are detected, including personal names, phone numbers, numerical numbers, specific phrases such as “family meal” or “hamburger” or “40 dollars” “car wash” etc. are imaged and stored for future recognition.

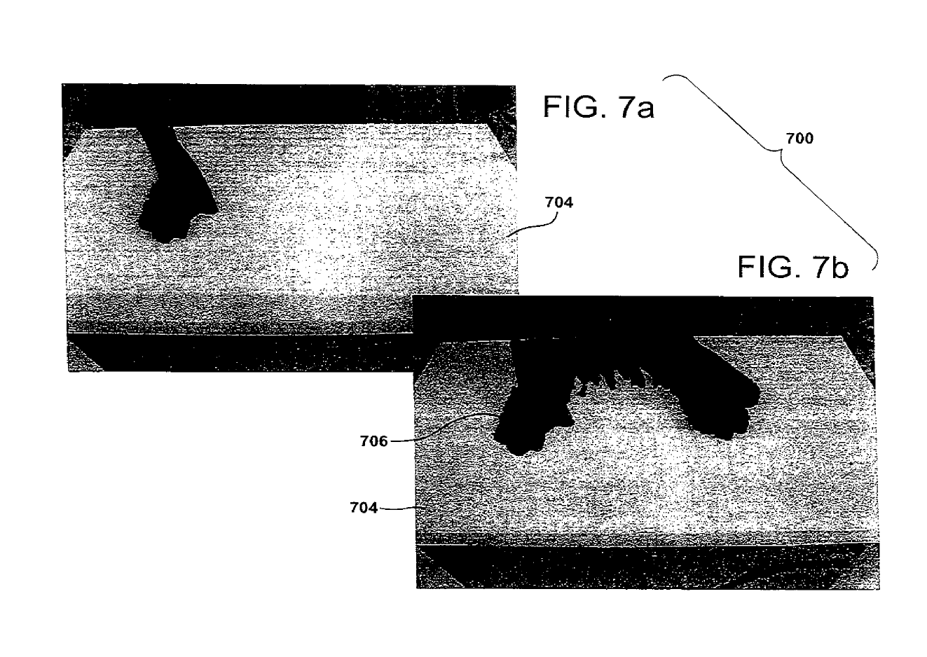

As shown in FIGS. 7a and 7b, a non-contact vision system 700 is illustrated, which system 700 is capable of detecting a table or floor area that has been used by a person or is contaminated. In as shown in FIG. 7a, the unadulterated portion 702 of the table (or floor) 704 appears white. As shown in FIG. 7b when a user places their hands (or plates, cups, equipment, furniture, carts, gurneys, or other items on a portion of the floor or table) that portion 706 of the view field is then darkened in color. This alerts to areas 706 of the table or floor have been used since prior cleaning, washing or disinfecting. In some embodiments, the images are saved to a network for future use. Such information can determine how frequently different tables, table areas, floors, floor areas, or routes or floors are utilized. Such data may determine what areas require the most or a more thorough cleaning or disinfecting.

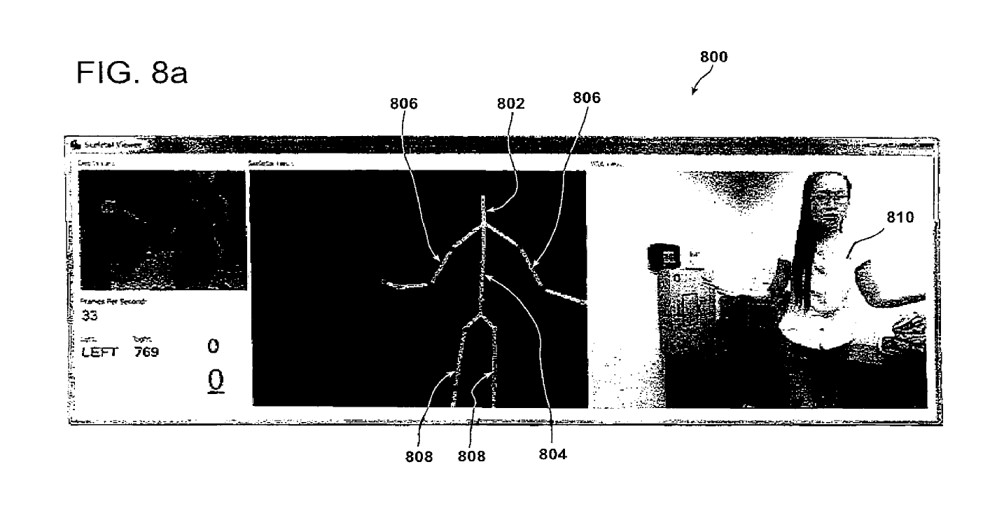

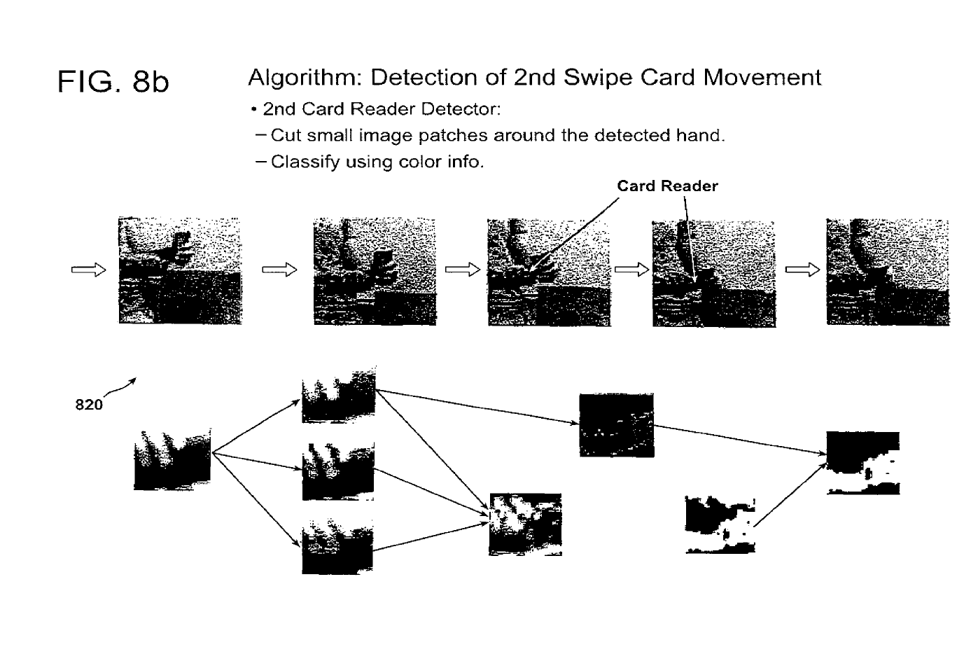

FIG. 8a illustrates an embodiment of a visual detection system 800 for the fraudulent swiping of credit cards in a customer drive through setting used in connection with an order facilitation process. In this embodiment, a camera (not illustrated) is capable of visually detecting the full body movement of an employee 810 including head, neck 802, torso 804, arms 806, and legs 808 within a vision field. A recording of individual receiving a credit or debit card and swiping through the machine may be made. Use of this data and comparing the body movements may aid in determining if the employee swipes the card through a different reader. In a second example, a recording of the individual 810 receiving cash and placing that cash into a cash register may be made. Use of this data and comparing the body movement may aid in determining if the employee takes the money and places the money in a pocket, purse or other location, i.e, other than the proper cash register.

As shown in FIG. 8b shows a visual detection system 820 for the fraudulent swiping of credit cards in a customer drive through setting used in connection with an order facilitation process according to one embodiment. In one embodiment, a camera (not illustrated) is capable to visually detecting the localized hand movement of an employee. A recording of the individual swiping the credit card or debit card through the machine may be made. Use of this data and comparing the hand movements may aid in determining if the employee swipes the card through a different reader (such as through a portable reader or smart phone).

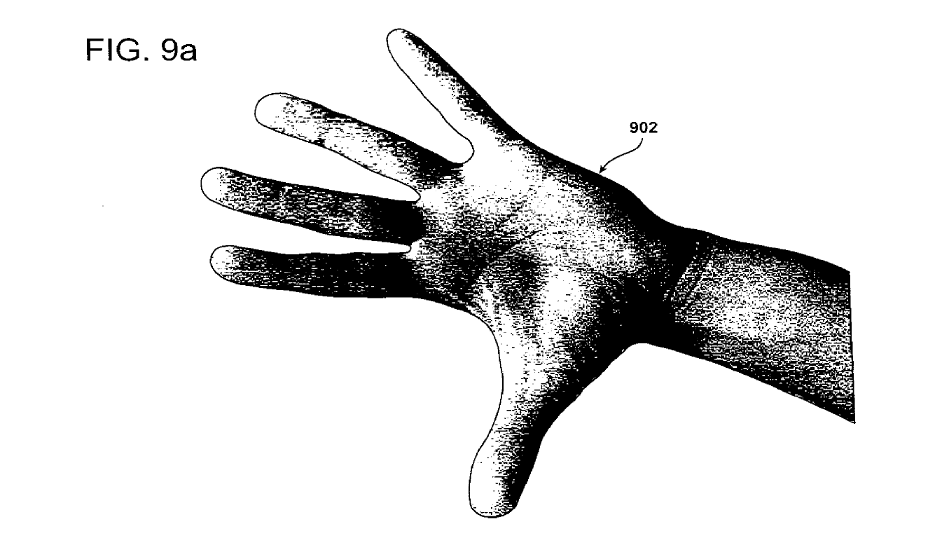

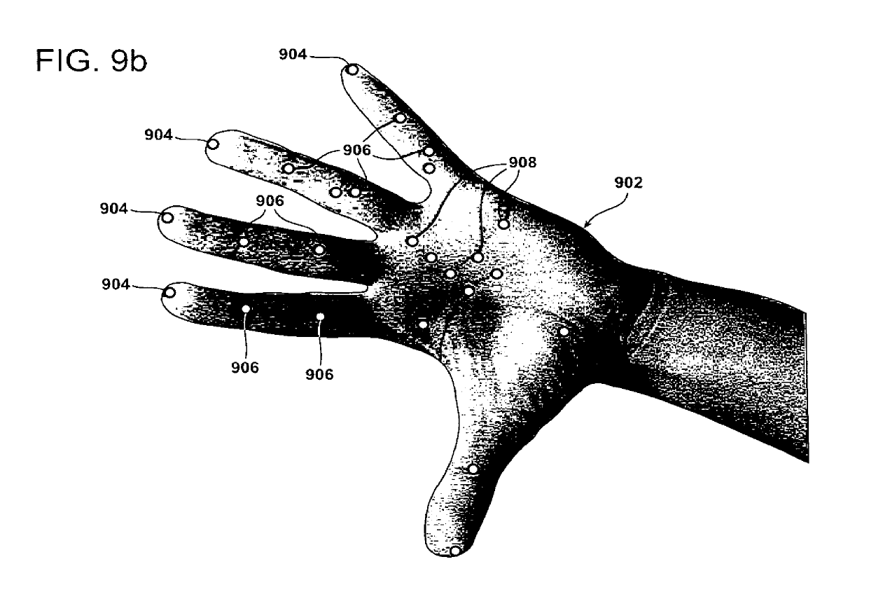

FIGS. 9a and 9b illustrate a visual detection system for non contact biometric sensing used in connection with the following invention. As shown in FIG. 9a, the topography of a human hand 902 is displayed. In FIG. 9b the key topographical landmarks of key aspect of a hand that may be received by a vision camera (not illustrated) and digitally recorded is displayed. In some instances, the number of fingers is noted, in some instances landmarks such as the tips 904 of each digit, the knuckle creases 906 of each digit, the creases 908 of the palm, and base 910 of palm are noted. In some embodiments, the images are saved to a network for future use.

In some embodiments the data is complied and processed and formatted into a report for a managers' or business owners' review. The data may identify the most utilized areas of business, the numbers of consumers frequenting the establishment, and the employees that are conspiring to defraud the customers or the business owners. The data may be represented in charts, graphs, or visual written reports.

In some embodiments, the data generated by the recordation and identification of a user is used to provide information regarding efficiency of a place of business for serving a product. In some instances it may provide data relating to use of an area and predicting repair or cleaning time scheduling. In some instances it may provide data regarding loss of revenue. In some instances it may provide increased accuracy of orders. In some instances it may provide increased customer service and satisfaction. As a result, the system may provide increased sales, and decreased loss of revenue, and consumers are more likely to return to a place of business after having an easy, convenient, clean experience.

The process for increasing the efficiency of an ordering process can be implemented according to any of the embodiments in order to obtain several advantages, if desired. The invention can provide an effective and cost-efficient detection and monitoring system with reduced costs, increased ease of use and unobtrusive redundancy in order to provide accurate results. The various embodiments described above are provided by way of illustration only and should not be construed to limit the invention. Those skilled in the art will readily recognize the various modifications and changes which may be made to the present invention without strictly following the exemplary embodiments illustrated and described herein, and without departing from the true spirit and scope of the present invention, which are set forth in the following claims.

1. A process for increasing the efficiency of an ordering process comprising:
determining the identity of an individual using a computer vision system;
facilitating an ordering of a good using the computer vision system; and
verifying completion of the order using the computer vision system.

2. The process of claim 1, wherein the determining the identity of the individual includes visually detecting and reading at least one member selected from the group consisting of a customer's vehicle's license plate, a face of the individual.

3. (canceled)

4. The process of claim 1, further comprising presenting the individual an option to select from past orders after the determining the individual's identity.

5. The process of claim 1, wherein the facilitating comprises at least one member selected from the group consisting of visually detecting an affirmation by the individual, and visually detecting a negation by the individual.

6. (canceled)

7. (canceled)

8. (canceled)

9. The process of claim 1, wherein the verifying includes confirming with the computer vision system that the individual receives an ordered good.

10. The process of claim 1, further comprising at least one member selected from the group consisting of
(i) determining a location of the individual and transmitting the location to a robot or a conveyance system;
(ii) determining with the computer vision system when a customer has completed eating, and the good comprises food;
(iii) determining with the computer vision system when an invoice has been delivered to the individual;
(iv) determining with the computer vision system whether a fraudulent financial transaction has occurred;
(v) determining with the computer vision system cleanliness of an environment used by the individual
(vi) determining with the computer vision system a time period for which a customer has been waiting to be served, and
(vii) determining with the computer vision system an item for sale ordered by the individual and identifying the individual who made the order.

11. (canceled)

12. (canceled)

13. (canceled)

14. The process of claim 1, wherein the computer vision system is capable of obtaining and processing dimensional video information.

15. (canceled)

16. The process of claim 15, further comprising tracking with the computer vision system the individual's interaction with the environment or an object in the environment, and cleaning the affected environment or object.

17. A process for identifying a person placing an order for merchandise or a consumable product utilizing a computer-based non-contact biometric identification system comprising:
providing a recording of a user at an ordering station for the merchandise or consumable product;
comparing the recording to stored recordings of users and orderings;
identifying the user based upon the comparing; and
generating a report of the identity of the user.

18. The process of claim 17, wherein the ordering station is a drive through, kiosk, vending machine, retail store, retail booth, or automated teller machine.

19. The process of claim 17, wherein the recording is captured via a camera.

20. The process of claim 17, wherein the recording comprises an image, an audio, a video, or a combination thereof.

21. The process of claim 17, wherein the comparing comprises detecting with the recording, a location of a body part near the ordering station, a personal item worn by the user, a license plate of a car driven by the user, or a combination thereof.

22. The process of claim 17, wherein the recording is digital.

23. The process of claim 1, further comprising reporting one or more of the order, fraud detection, time to service, time to clean, employee performance, cash activity, credit card activity.

24. The process of claim 1, further comprising integrating the computer vision system with existing customer sales systems.

25. The process of claim 1, wherein the computer vision system is deployed in at least one member selected from the group consisting of a drive-thru, and a food retailer.

26. (canceled)

27. The process of claim 1, further comprising at least one member selected from the group consisting of
(i) accepting a payment for the order by visually scanning a credit card number; and
(ii) accepting a payment for the order wherein the computer vision system determines the cash delivered by the individual and the change being returned to the individual.

28. (canceled)

29. A system as claimed in the claims above.

30. A computer program implementing the process as claimed in the claims above.
